(19) United States
(12) Patent Application Publication
(10) Pub. No.: US 2009/0009923 A1
(43) Pub. Date: Jan. 8, 2009

(54) Refrigerating chamber ion engine which produces cold air and attracts static electricity and its positively charged ion molecules inside of this retain ionization accelerator chamber. This acts like a super conductive magnet swarming inside of the cold air without neutralizing its energy and retains its force. Thermal ionized air is and even stronger super conductive magnet which this field or swarm of positively charged ion molecules swarm to and follows. Once substantial energy is stored within this field of cold air the heated ionized air particles matching the outside air temperature is

(76) Inventor: Todd J. Tocco, Schenectady, NY (US)

Correspondence Address: Todd J. Tocco, 2014 Fiero Avenue, Schenectady, NY, 12303-4109, US

(21) Appl. No.: 11/713,063

(22) Filed: Mar. 2, 2007

(51) Int. Cl. H01T 23/00; H02N 1/00; H05H 1/00

(52) U.S. Cl. 361/231; 310/309; 60/202

(57) ABSTRACT

Static electricity or electrostatic generator static energy these positively charged ions can now be controlled by using my theory, a refrigerant repellent retain accelerator chamber, more simply put. A cold air chamber or refrigerating chamber like your home freezer or icebox which inside of it, you place a Van De Graaff generator or any type of static generator will work.

As the generator source as it creates static electricity or positively charged ions molecules the acceleration of positively charged ion molecules is drawn to the inside wall's of the ice box, like a super conductive magnet or sponge absorbing the static electricity energy as it builds up without neutralizing the positively charged ion molecules.

Thermal or heated ionized air particles matching the outside air temperature is then blown through the freezer which the positively charged ion molecules follow through the ion jetting port's thus creating anti-gravity propulsion.

### INVENTION BACKGROUND

Physical and electrical principles involved in the generation of this source of static electricity and. The molecular theory of matter structure states that each molecule of a body is composed of positive and negative charges. The positive charges are contained in the nucleus of the molecule, while the negative charges or electrons, and are free to orbit around the positively charged nucleus. In a molecule that is neutral or uncharged, the sum of the negatively charged orbiting electrons is equal to the sum of the positive charges in the nucleus. Any matter composed of all neutral molecules is also neutral. Under certain conditions, some molecules do not have enough force or attraction between the positive nucleus and the negative orbiting electrons to keep all electrons in orbit. In this case, the outermost orbiting electrons, which are called valence electrons, tend to be attracted to an adjacent molecule with a greater force of attraction, leaving an excess of positive charges in the nucleus. The molecule thus becomes positively charged. In the reverse, some molecules tend to pick up additional electrons, causing an imbalance, and resulting in a negatively charged molecule. Any matter with excess negative molecules becomes negatively charged, and conversely, matter with excess positive molecules becomes positively charged.

### INVENTION BACKGROUND

Objects or materials can become charged by friction, or more simply, just contact and separation of two materials. When two objects or materials are brought into intimate contact, the valence electrons nearest the surface of the material move freely about, from molecule to molecule, from material to material, until they attach themselves to stronger nuclei. Upon separation of the materials, one material loses electrons and becomes positively charged. The other gains electrons and becomes negatively charged. As the pressure or speed of contact and separation or friction increases between the two materials, the static charge voltage increases. Another means by which an object or material may become charged is by induction. A highly charged object results in a static field around the object. If an isolated or ungrounded conductive object enters into this static field, it too will become charged, but of the opposite polarity. This sets the stage for a possible electrostatic discharge to some other conductive object, which to could result in an arc of sufficient energy.

### Subject Matter

I claim: To better understand the Tocco theory, and it principles' you need to know a little about how it works. To do that you need to understand static electricity, almost all of us are familiar with static electricity because we can see and feel it. Especially during the colder weather on those dry winter days and nights. Static electricity can build up in our bodies and cause a spark to jump from our bodies to pieces of metal or other people's bodies. My theory states static electricity or positively charged ions molecules are attracted to cold air which it builds up and becomes trapped inside of the ice cold refrigerating chamber where it then becomes dormant in this retain chamber which acts like a super conductive magnet drawing in vast amounts of positively charged ion molecules like what I call a swarm. But this is the secondary as static electricity is also attracted to what I believe to be the primary that is thermal heat or warmer air. It also can be referred to as friction especially thermal heated ionized air particles.

Which gains positive molecules and is void of negatively charged electrons, I call this the (PCI Swarm) short for positively charged ion molecules swarm. As friction is what I believe to be a positive factor or the lifting force behind the static electricity, and the shocking part of static cling. What I mean to say is when an object that is warmer or hotter like the thermal heated ionized air that is blown in the ice cold refrigerating chamber or another name is the ionization chamber using a ionized type of heating element as this blows through the ice cold refrigerating chamber.

### Subject Matter

Say if you were to use just hot air I don't believe it would be as effective as electrifying the air molecules this is what attracts the already present positively charged ions molecules thermal heated element this factor is one of the primary keys to unlocking this new type of ion engine plus the (refrigerant repellent retain accelerator chamber which is a refrigerator ice box the static electricity or positively charged ion molecules build up and follows the primary heated molecules or ionized air particles out. The heated molecules are attracted to this even stronger super conductive magnet. That is the thermal ionized air these positively charged ion molecules can now be used as a new type of energy source and is what gives my hover craft ion engine its lift and maneuvering ability. You see as cold air attracts static electricity, matter with excess positive ion molecules becomes positively charged. Another example would be if you were to place a static generator in an air condensation room and attach tissue paper to the dome of the generator, you would see the lifting force at work. As the static energy tries to move towards the cold air in the room this is the key to my theory and the lifting force to my engine. As static electricity is created within the ice cold refrigerating chamber it could also be called a ionization chamber the acceleration of the dormant particle it accumulates.

Until the point of discharge when the thermal ionized air is blown through the ionization chamber and all positively charged ions or swarm follow that ion jet stream out the interior content of this chamber is collected which consist of all the positively charged ions molecules or (PCI Swarm) as they follow the hotter or warmer air out. This is what pulls the static electricity build up in doors in the winter months by the heat of our body's plus the low levels of electricity already present and this is a principle behind my theory that static electricity is all around us but any evidence of that isn't apparent until the cold winter months that's because static electricity builds up out doors, and heated object pass through it like our bodies. You see our bodies are like hydrogen powered motors that creates heat and a electrical field of energy. It then follows us in doors static electricity or electrostatic generators static energy can now be control by using this man made (refrigerant repellent retain accelerator chamber). Its configuration makes up the interior outer chamber a refrigerant repellent circulates inside of this stainless steel ice cold refrigerating chamber or ionization chamber, similar to a refrigerator ice box this is surrounding any type of electrostatic generator which is then coated with a temper proof glass exoskeleton. This glass static insulation barrier which cover's the interior exterior of the ice cold refrigerating chamber or ionization chamber where the positively charged ion molecules are formed. And retain's the static electricity energy and its build up once substantial energy is stored, from within the ice cold refrigerating chamber the heated ionized air particles matching the outside air temperatures are then blown across through the ice cold refrigerating chamber. With something like a ionized hair dryer which the static energy or (PCI Swarm) forced out it's this discharge of static energy that is redirected to the static energy ion directional jetting system. This is used as propulsion for my antigravity hover craft ion engine. I have seen static generators as small as a soda cans, or as big as a school bus. So any configuration or dimension can be used several small ionized air jet's are used these limits the amount of static electricity ion energy discharge to exit through the static energy jets at any given time. And only allows passage of the electrostatic energy or positively charged ion molecules to exit through one or more of the static electricity energy jets, the refrigerant repellent cold air chamber or ionization chamber is a barrier that retain's and control's the flow of this (PCI Swarm) of static electricity energy. This new ion engine is designed to be flat like a plasma screen not round, like your typical Van De Graaff generator. It could be any shape size or dimension that fits inside of a ice cold refrigerating chamber or more simply put a like your home refrigerator ice box or freezer. This ion engine works by the repelling force of the static electricity or the positively charged ion molecules and the heated ionized air particles as the (PCI Swarm) leaves or is pulled away from the ice cold refrigerating chamber. Which the (PCI Swarm) follows thermal energy as the primary heat or hot ionized air particles that matches as close to the outside air temperature as possible. This ion engine can have any typically built static generator, of any configuration or size or shape as.the energy source for this ion engine it is then placed inside of the refrigerating chamber like after you place a van de graaff generator or any type of static generator will work. As the generator source, as it creates static electricity or positively charged ions molecules around it there should be a temper proof glass exoskeleton insulation barrier which prevents the static energy from escaping from the refrigerating chamber and to keep anyone from getting a nice surprise of a couple of thousand volts of electricity discharge. The cold air is to retain and for controlling the positively charged ion molecules formed from within the refrigerating chamber similar to your home ice box or freezer the static electricity field within the refrigerating chamber retain the positively charged ion molecules field without naturalizing the positively charged ion molecules and it retains its force which becomes dormant like, which makes it possible to uses this swarm of positively charged ion molecules which are created within the ice cold chamber for a ion engine with a thermal ionized air duct inlet which pushes or pulls with a heavy duty ionized motor moves the once dormant positively charged ion molecules outwardly to the ion jetting ports with one or more of these ports for propulsion which is also air ducted out of this ice cold refrigerating chamber to the directional ion jetting system which is used for lifting and maneuvering the craft in any or all directions Let's say the outside atmospheric temperature is zero and inside the freezer temperature is also a zero because the primary is the thermal ionized air which is warmer the (PCI Swarm) will follow that air supply or jet stream out which creates lift, from the to repelling each other as the warmer air now ionized jet stream is the stronger force the drawing in of vast amount's of this super conductive energy or positively charged ion energy. The engine can be any shape size or dimension that's because static generators are all different each one of them can be used. That's because any type of static generator that can produce static energy can create the positively charged ions then it is be placed inside of the thermal accelerator or more simply put a refrigerator ice box or freezer. On one side of the cold refrigerating chamber there is the heating port. Which the thermal ionized air is injected into the ice cold box and on the other side is the directional ion jetting system air duct where the swarm of positively charged ion are jetted out with the ion jet stream field which forces and repels from the earths atmospheric conditions or thermal temperature field.

This force is achieved once substantial positively charged ions are created they are pulled from the ice cold refrigerating chamber by the thermal ionizing jet stream and follows through the ice cold refrigerating chamber to the ion jetting system as now heated ionized jet stream of positively charged ion molecules as this energy leaves without losing any strength. This forces the craft in any given direction while repelling the vehicle upward a forward from the ground.

### Webster's New World Dictionary

Ion: An electrically charged atom or group of atoms the electrical charged of which results when a neutral atom or group of atoms loses or gains one or more electrons during chemical reactions by the action of certain forms of radiant energy, etc: the loss of electrons results in a positively charged ion

Ion engine: A reaction engine, as for space vehicles', that uses for propulsion a stream of ionized heavy atoms or molecules accelerated by an electrostatic field

Ionize: To charge or to be charged into ions

Ionized: To charge or to be charged into ions

Ionizing: To charge or to be charged into ions

### The American Heritage Dictionary of The English Language Third Edition

Accelerate: To increase the speed of. 2. To cause to occur sooner than expected. 3. To cause to develop or progress more quickly: a substance used to accelerate a fire.4.a. To speed up (an academic course.for example).b. To make it possible for (a student) to finish an academic course faster than usual.5.Physics. To cause a change of velocity-intr. 1. To move or act faster. See synonyms at speed.2. To engage in an academic program that progresses faster than usual

Acceleration: 1.a. The act of accelerating. B. The process of being accelerated 2. abbr.a Physics The rate of change of velocity with respect to time

### Webster's New World Dictionary

Refrigerant: that refrigerates; cooling or freezing something reducing heat or fever a medicine used to reduce fever a substance used in refrigeration; specif., any of various liquids that vaporize at low temperature, used in mechanical refrigeration

Refrigerate: refigerare, to make cool or cold <re-, Intens.+frigerare, to cool <frigus, cold: see FRIGID] to make or keep cool or cold; chill to preserve (food, biologicals, etc.) by keeping cold or freezing—refrigeration—re-frig'er-a'tive, re-frig'er-a-to'ry adj.

Refrigerator: re-frig-er-a-tor something that refrigerates; esp., a box, cabinet, or room in which food, drink, etc. are kept cool, as by ice or mechanical refrigeration

Repel: to drive back or force back; hold or ward off to repel an attack to refuse to accept, agree to, or submit to; reject to repel advances to refuse to accept a person); spurn to repel a suitor to cause distaste or dislike in; disgust the odor repelled him to cause insects,etc) to react by staying away to be resistant to, or present an opposing force to [a coating that repels moisture] to fail to mix with or adhere to water repels oil to drive off, or offer an opposing force to something to cause distaste, dislike, or aversion

Repellent: that repels; pushing away or driving back a causing distaste, dislike, or aversion; repulsive causing insects etc. to react by staying away able to resist the absorption of liquid; esp. water,to a limited extent a water-repellent raincoat something that repels; specif., a solution applied to fabric to make it water-repellent any substance used to repel insects Also re-pel'lant -re-pel'lence, re-pel'-len-cy- re-pel'lent-ly

### Wikipedia

### The Free Encyclopedia

Anti-gravity: is a recurring theme in science fiction, particularly in the context spacecraft propulsion. Often a special “gravity shield” or “anti-gravity force field” cancels the effects of gravity, allowing a spacecraft to accelerate (cf. warp drive). Unfortunately science has as yet failed to find any such force, and the present laws of physics appear to rule out the possibility of anti-gravity. Nonetheless, some have studied possible methods of achieving such effects.

Propulsion: The process of causing a body to move by exerting a force against it. Propulsion is based on the reaction principle, stated qualitatively in Newton's third law, that for every action there is an equal and opposite reaction. A quantitative description of the propulsive force exerted on a body is given by Newton's second law, which states that the force applied to any body is equal to the rate of change of momentum of that body, and is exerted in the same direction as the momentum change.

Electromagnetic field: exerts on electrically charged particles, called the electromagnetic force, is one of the four fundamental forces. The other fundamental forces are the strong nuclear force (which holds atomic nuclei together), the weak nuclear force (which causes certain forms of radioactive decay), and the gravitational force. All other forces are ultimately derived from these fundamental forces. Plasma: One of four states of matter (solid, liquid, plasma and gas). The plasma state is a gas that is heated to the point where it begins to release electrons. Although plasma occurs naturally on the sun and other stars, it is artificially produced in fluorescent lights and plasma displays by electrically charging a gas

### Wikipedia

### The Free Encyclopedia

Electrostatic generator: The noun electrostatic generator has one meaning: Meaning #1: electrical device that produces a high voltage by building up a charge of static electricity Synonyms: electrostatic machine, Wimshurst machine, Van de Graaff generator Van De Graaff generator: The noun Van de Graaff generator has one meaning: Meaning #1: electrical device that produces a high voltage by building up a charge of static electricity Synonyms: electrostatic generator, electrostatic machine, Wimshurst machine An electrostatic generator in which an electric charge is either removed from or transferred to a large hollow spherical electrode by a rapidly moving belt, accelerating particles to energies of about ten million electron volts.

Tocco: The noun Tocco has of one meaning: Meaning #1: to retain and control static electricity and its positively charged ion molecules with a refrigerating chamber of cold air which retain these dormant molecules without naturalizing the energy and retains there force

### RESEARCH

### Effects of Static Electricity

Static electricity has long been a problem in many industrial and commercial operations and is a serious hazard especially in explosive atmospheres and in areas where flammable solvents or materials are present. Not only is the sudden discharge, or arcing, of static electricity responsible for fires and explosions, but it also causes losses in the millions of dollars to manufacturers in machinery downtime and lost man-hours, and in product loss particularly in the semiconductor and electronics industries where static sensitive components are degraded or destroyed by only a'few volts of static electricity. For the user of sophisticated electronics, static causes loss of memory, falseinputs, etc., to electronic memory equipment such as computers, data terminals and word processors.

The effects of static electricity in manufacturing processes have become more and more of a problem with

The widespread use of synthetic materials and high-speed machinery. Some plastics, for example, when traveling through a machine, may develop static charges of several thousand volts. These highly charged materials are sometimes attracted to machine rollers or guides causing jams and even damage to the machinery. This same highly charged material, if rewound onto a large roll as in a slitting and rewind converting operation, can become a huge capacitor, capable of storing in excess of 50,000 volts of static electricity. This highly charged “capacitor” could cause uncomfortable shocks to operators, even burns, or injury due to physical reaction from receiving a shock. This “capacitor” could arc to a nearby conductor and produce a strong arc several inches long, easily causing a fire or explosion if in the right situation. In critical areas such as food and drug packaging, semiconductor and biomedical products manufacturing, and virtually any process requiring clean room procedures or simply a clean product, static becomes a problem. Any part or material supporting a static charge will attract contamination whether it is in the form of microscopic size dust particles, or dust and chips from machining.

Most static-related problems, however simple or complex they may seem, can be solved once the problem is addressed, analyzed and the proper control methods are implemented and adhered to.

Replacement Method—Ionization: If the missing electrons in a positive charged material can be replaced, or if a negative charged material can be made to absorb positive ions, the material can be neutralized. This process is made possible through ionization, which is the splitting of air molecules into positive and negative charges. An ionizing device emits quantities of negative and positive ions in the vicinity of the static charged object. Since opposite charges attract, the charged object takes on a sufficient number of negative or positive ions, depending upon which is required for neutralization. This ionizing device acts as an infinite source for negative and positive ions.

### Methods of Ionization

There are three basic types of equipment available for producing ionization: electrically powered high voltage static neutralizing equipment, nuclear powered equipment and induction-type neutralizers. Ionizing Air Blowers are probably one of the most versatile types of equipment available for neutralizing static. They are available in portable models for bench-top operation or in models for permanent mounting. These units are capable of neutralizing materials up to 10 feet away and are especially suited for odd-shaped parts and materials as well as web and sheet materials. Ionizing blowers consist of a housing containing a fan that blows air through either a grid or electrically powered static neutralizing bars or a nuclear material. Any objects or materials in the air stream are neutralized. For hazardous locations, X-Proof electrical and nuclear units are available.

### Conflicting Definitions for “Static Electricity”

1. Static electricity Is a field of science. some people call it “Electrostatics.” Same thing. So, if Static Electricity is a kind of science, then it can't be made by generators. In a similar way, you can slice open a dead frog, but you'll never find any biology inside. And rocks don't contain any tiny pieces of “geology.” Remember: Hydrostatics is the study of fluid pressure, Newtonian Statics is the study of physical forces, and Static Electricity is the study of charge, voltage, and electrical forces. Where can we find static electricity? Physics books are full of static electricity. So are certain buildings at the University!2. Static electricity is a set of events which humans have grouped together. Sparks and lightning are “static electricity,” even though sparks and lightning are about the most dynamic things imaginable. Also, “dryer cling” is static electricity. Make no mistake, the “static” isn't inside the clothes, since “static” is not a stuff. The cling effect, That is the electricity. After all, “electricity” can mean “a class of phenomenon.” And having your socks stick to the back of your sweater is certainly a phenomenon. Where does static electricity come from? From human minds: same as with “weather” and “bureaucracy” and all other classes of phenomenon.

3. Static electricity is another word for high voltage. Whenever we have high voltage, then we also have electrostatic attraction and repulsion. High voltage can attract lint or tiny bits of paper, and it can make hair stand up. With high voltage we also get long sparks, crackling noises, and blue glows and flashes. High voltage makes ozone; the stuff that gives that funny chlorine smell. These things are the hallmarks of Static Electricity, but they are never caused by the “static-ness” of electric charges. Instead they are caused by intense e-fields. Intense e-fields are another way of saying “high votlage.” If you can scuff your shoes on the carpet and then zap people with your finger, then you've been charging your body to several thousand volts.

4. Static Electricity means an imbalance of electric charge An electrically “charged” object contains more protons than electrons, or it contains more electrons than protons. Electrically neutral matter is made of positive and negative charges. Matter is made of atoms, and atoms contain closely-spaced electrons and protons. The “positives” and the “negatives” are very close together, so their effects cancel out. That's why electrical phenomena don't seem obvious in the everyday world. But if we accidentally remove a bunch of electrons from their atoms, and then we put these electrons in a distant spot, we'll leave behind a region of positive net charge. We'll also create an equal region of negative net charge.

These imbalances of charge will surround themselves with intense electrical fields or “e-fields.”

5. Static Electricity means FRICTIONAL charge-imbalance There are several ways to create an imbalance of charge upon an object. Suppose we use a high voltage power supply to separate some charge? No friction was involved, yet our charged object can attract paper and raise arm-hair. Sometimes we use the words “static electricity” to mean “triboelectricity” or “frictional electricity.” But this means that. . . if it wasn't created by friction, then it's not static electricity.

### REFERENCES CITED

### U.S. Patent Documents

### Static Electricity Propulsion Search:

Method and apparatus for converting electrostatic potential energy

US Patent Issued on Dec. 13, 2005 Inventor(s) Application No. 331007 filed on Dec. 27, 2002. Peter Grandics Current U.S. Class 244/172, With propulsion 244/62 AIRCRAFT PROPULSION Hybrid propulsion system Inventor(s) Application No. 10825924 filed on Apr. 15, 2004.

US Patent Issued on Jul. 4, 2006 Chris Grainger

I claim:

1. To better understand the Tocco theory, and it principles' you need to know a little about how it works. To do that you need to understand static electricity, almost all of us are familiar with static electricity because we can see and feel it. Especially during the colder weather on those dry winter days and nights. Static electricity can build up in our bodies and cause a spark to jump from our bodies to pieces of metal or other people's bodies. My theory states static electricity or positively charged ions molecules are attracted to cold air which it builds up and becomes trapped inside of the ice cold refrigerating chamber where it then becomes dormant in this retain chamber which acts like a super conductive magnet drawing in vast amounts of positively charged ion molecules like what I call a swarm. But this is the secondary as static electricity is also attracted to what I believe to be the primary that is thermal heat or warmer air. It also can be referred to as friction especially thermal heated ionized air particles. Which gains positive molecules and is void of negatively charged electrons, I call this the (PCI Swarm) short for positively charged ion molecules swarm. As friction is what I believe to be a positive factor or the lifting force behind the static electricity, and the shocking part of static cling. What I mean to say is when an object that is warmer or hotter like the thermal heated ionized air that is blown in the ice cold refrigerating chamber or another name is the ionization chamber using a ionized type of heating element as this blows through the ice cold refrigerating chamber. Say if you were to use just hot air I don't believe it would be as effective as electrifying the air molecules this is what attracts the already present positively charged ions molecules thermal heated element this factor is one of the primary keys to unlocking this new type of ion engine plus the (refrigerant repellent retain accelerator chamber which is a refrigerator ice box the static electricity or positively charged ion molecules build up and follows the primary heated molecules or ionized air particles out. The heated molecules are attracted to this even stronger super conductive magnet. That is the thermal ionized air these positively charged ion molecules can now be used as a new type of energy source and is what gives my hover craft ion engine its lift and maneuvering ability. You see as cold air attracts static electricity, matter with excess positive ion molecules becomes positively charged. Another example would be if you were to place a static generator in an air condensation room and attach tissue paper to the dome of the generator, you would see the lifting force at work. As the static energy tries to move towards the cold air in the room this is the key to my theory and the lifting force to my engine. As static electricity is created within the ice cold refrigerating chamber it could also be called a ionization chamber the acceleration of the dormant particle it accumulates. Until the point of discharge when the thermal ionized air is blown through the ionization chamber and all positively charged ions or swarm follow that ion jet stream out the interior content of this chamber is collected which consist of all the positively charged ions molecules or (PCI Swarm) as they follow the hotter or warmer air out. This is what pulls the static electricity build up in doors in the winter months by the heat of our body's plus the low levels of electricity already present and this is a principle behind my theory that static electricity is all around us but any evidence of that isn't apparent until the cold winter months that's because static electricity builds up out doors, and heated object pass through it like our bodies. You see our bodies are like hydrogen powered motors that creates heat and a electrical field of energy. It then follows us in doors static electricity or electrostatic generators static energy can now be control by using this man made (refrigerant repellent retain accelerator chamber). Its configuration makes up the interior outer chamber a refrigerant repellent circulates inside of this stainless steel ice cold refrigerating chamber or ionization chamber, similar to a refrigerator ice box this is surrounding any type of electrostatic generator which is then coated with a temper proof glass exoskeleton. This glass static insulation barrier which cover's the interior exterior of the ice cold refrigerating chamber or ionization chamber where the positively charged ion molecules are formed. And retain's the static electricity energy and its build up once substantial energy is stored, from within the ice cold refrigerating chamber the heated ionized air particles matching the outside air temperatures are then blown across through the ice cold refrigerating chamber. With something like a ionized hair dryer which the static energy or (PCI Swarm) forced out it's this discharge of static energy that is redirected to the static energy ion directional jetting system. This is used as propulsion for my antigravity hover craft ion engine. I have seen static generators as small as a soda cans, or as big as a school bus. So any configuration or dimension can be used several small ionized air jet's are used these limits the amount of static electricity ion-energy discharge to exit through the static energy jets at any given time. And only allows passage of the electrostatic energy or positively charged ion molecules to exit through one or more of the static electricity energy jets, the refrigerant repellent cold air chamber or ionization chamber is a barrier that retain's and control's the flow of this (PCI Swarm) of static electricity energy. This new ion engine is designed to be flat like a plasma screen not round, like your typical Van De Graaff generator. It could be any shape size or dimension that fits inside of a ice cold refrigerating chamber or more simply put a like your home refrigerator ice box or freezer. This ion engine works by the repelling force of the static electricity or the positively charged ion molecules and the heated ionized air particles as the (PCI Swarm) leaves or is pulled away from the ice cold refrigerating chamber. Which the (PCI Swarm) follows thermal energy as the primary heat or hot ionized air particles that matches as close to the outside air temperature as possible. This ion engine can have any typically built static generator, of any configuration or size or shape as the energy source for this ion engine it is then placed inside of the refrigerating chamber like after you place a van de graaff generator or any type of static generator will work. As the generator source, as it creates static electricity or positively charged ions molecules around it there should be a temper proof glass exoskeleton insulation barrier which prevents the static energy from escaping from the refrigerating chamber and to keep anyone from getting a nice surprise of a couple of thousand volts of electricity discharge. The cold air is to retain and for controlling the positively charged ion molecules formed from within the refrigerating chamber similar to your home ice box or freezer the static electricity field within the refrigerating chamber retain the positively charged ion molecules field without naturalizing the positively charged ion molecules and it retains its force which becomes dormant like, which makes it possible to uses this swarm of positively charged ion molecules which are created within the ice cold.chamber for a ion engine with a thermal ionized air duct inlet which pushes or pulls with a heavy duty ionized motor moves the once dormant positively charged ion molecules outwardly to the ion jetting ports with one or more of these ports for propulsion which is also air ducted out of this ice cold refrigerating chamber to the directional ion jetting system which is used for lifting and maneuvering the craft in any or all directions Let's say the outside atmospheric temperature is zero and inside the freezer temperature is also a zero because the primary is the thermal ionized air which is warmer the (PCI Swarm) will follow that air supply or jet stream out which creates lift, from the to repelling each other as the warmer air now ionized jet stream is the stronger force the drawing in of vast amount's of this super conductive energy or positively charged ion energy. The engine can be any shape size or dimension that's because static generators are all different each one of them can be used. That's because any type of static generator that can produce static energy can create the positively charged ions then it is be placed inside of the thermal accelerator or more simply put a refrigerator ice box or freezer. On one side of the cold refrigerating chamber there is the heating port. Which the thermal ionized air is injected into the ice cold box and on the other side is the directional ion jetting system air duct where the swarm of positively charged ion are jetted out with the ion jet stream field which forces and repels from the earths atmospheric conditions or thermal temperature field.
Subject Matter
This force is achieved once substantial positively charged ions are created they are pulled from the ice cold refrigerating chamber by the thermal ionizing jet stream and follows through the ice cold refrigerating chamber to the ion jetting system as now heated ionized jet stream of positively charged ion molecules as this energy leaves without losing any strength. This forces the craft in any given direction while repelling the vehicle upward a forward from the ground.
